(19) United States
(12) Patent Application Publication
(10) Pub. No.: US 2017/0330074 A1
(43) Pub. Date: Nov. 16, 2017

(54) Methods And Systems For Providing Travel Recommendations

(71) Applicant: The Board Of Regents Of The Nevada System Of Higher Education On Behalf Of The University Of NV, Las Vegas, NV (US)

(72) Inventor: Brittney Martino, Las Vegas, NV (US)

(21) Appl. No.: 15/592,846

(22) Filed: May 11, 2017

Related U.S. Application Data
(60) Provisional application No. 62/484,616, filed on Apr. 12, 2017.
(60) Provisional application No. 62/334,871, filed on May 11, 2016.

(51) Int. Cl. G06N 3/08; G06Q 30/06; G06N 5/04

(52) U.S. Cl. CPC G06N 3/08; G06N 5/04; G06Q 30/0631

(57) ABSTRACT

Systems and methods are described for receiving travel data associated with a user, generating a predictive model, receiving additional travel data associated with the user, and generating, based on applying the predictive model to the additional travel data, one or more recommendations.

### CROSS REFERENCE TO RELATED PATENT APPLICATIONS

This application claims priority to U.S. Provisional Application No. 62/334,871, filed May 11, 2016, and to U.S. Provisional Application No. 62/484,616, filed Apr. 12, 2017, herein incorporated by reference in their entireties.

### BACKGROUND

Currently, systems exist to provide travel-related information to individuals. For example, once an individual makes a travel booking a confirmation email containing travel information (e.g., flight, hotel, car rental, etc.) can be forwarded to an email address and used to generate a travel itinerary. Unfortunately, individuals utilizing such a service may not always be aware of changes affecting their travel plans (e.g., canceled flight, car rental unavailable, etc.), or they may not always be aware of events and/or activities occurring at or within close proximity to their travel destination or travel route. Additionally, individuals that make routine behavioral choices (e.g., visiting a coffee shop before each flight, stopping for a particular type of meal whenever arriving in a major city, staying at a favorite hotel, etc.) during their travel may be unaware of opportunities, events, or other occurrences of interest associated with their routine behavioral choices that may be occurring at their travel destination or along their travel route (e.g., discounts offered at a frequently visited coffee shop). These and other shortcomings are addressed by the present disclosure.

### SUMMARY

It is to be understood that both the following general description and the following detailed description are exemplary and explanatory only and are not restrictive. Provided are methods and systems for methods and systems for analyzing travel data and determining associated user recommendations.

Systems and methods are described for receiving travel data associated with a user, generating a predictive model, receiving additional travel data associated with the user, and generating, based on applying the predictive model to the additional travel data, one or more recommendations.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram of an exemplary system;

FIG. 2 is a flowchart illustrating an example method;

FIG. 3 is a view of a the mobile device interface;

FIG. 4 is a view of a the mobile device interface:

FIG. 5 is a view of a the mobile device interface; and

FIG. 6 is a block diagram of another exemplary system.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present disclosure relates to methods and systems for providing user specific itinerary recommendations based on user behavior and travel-related information. Travel-related information (also referred to herein as travel information) can comprise itinerary information associated with a user received from a one or more service providers such as a travel company (e.g., airline, train, ship, etc. . . . ), a hotel, a restaurant, an event space, combinations thereof, and the like. User behavior includes, for example, user interactions with other users, user locations, user purchases, and the like along with associated times/dates. User behavior can be determined by monitoring one or more user accounts, monitoring usage of one or more user devices (e.g., GPS, messaging, phone calls, etc. . . . ), combinations thereof, and the like. A comprehensive travel itinerary based on one or more logical relationships between one or more travel events can be generated based on the travel-related information and the user behavior. A travel event can be any occurrence/interaction between a user and anything (e.g., landing at an airport, purchasing coffee, staying at a hotel) that a user may do/encounter during the course of travel. The comprehensive travel itinerary can comprise recommendations for the user, such as specific travel events of interest.

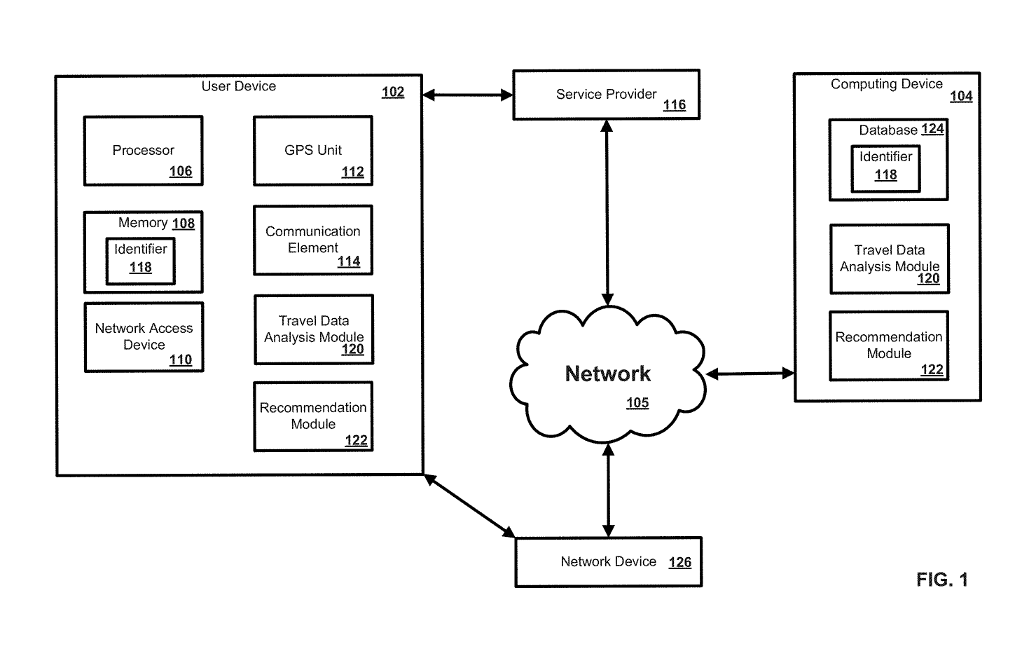

FIG. 1 illustrates various aspects of an exemplary environment in which the present methods and systems can operate. One skilled in the art will appreciate that provided herein is a functional description and that the respective functions can be performed by software, hardware, or a combination of software and hardware.

In an aspect, disclosed is a user device 102 in communication with a computing device 104 such as a server, for example. In an aspect, the user device 102 can be an electronic device such as a computer, a smartphone, a laptop, a tablet, a computing device, or other device capable of communicating with the computing device 104. The computing device 104 can be disposed locally or remotely relative to the user device 102. As an example, the user device 102 and the computing device 104 can be in communication via a private and/or public network 105 such as the Internet, a local area network, a wide area network, a cellular network, a satellite network, combinations thereof, and the like. Other forms of communications can be used such as other wired and wireless telecommunication channels, for example.

The user device 102 can comprise a processor 106. The processor 106 can be, or can comprise, any suitable microprocessor or microcontroller, for example, a low-power application-specific controller (ASIC) and/or a field programmable gate array (FPGA) designed or programmed specifically for the task of controlling a device as described herein, or a general purpose central processing unit (CPU), for example, one based on 80x86 architecture as designed by Intel™ or AMD™, or a system-on-a-chip as designed by ARM™. The processor 106 can be coupled (e.g., communicatively, operatively, etc. . . . ) to auxiliary devices or modules of the user device 102 using a bus or other coupling.

The user device 102 can comprise a non-transitory memory device 108 coupled to the processor 106. The memory device 108 can comprise a random access memory (RAM) configured for storing program instructions and data for execution or processing by the processor 106 during control of the user device 102. When the user device 102 is powered off or in an inactive state, program instructions and data can be stored in a long-term memory, for example, a non-volatile magnetic optical, or electronic memory storage device (not shown). Either or both of the RAM or the long-term memory can comprise a non-transitory computer-readable medium storing program instructions that, when executed by the processor 106, cause the user device 102 to perform all or part of one or more methods and/or operations described herein. Program instructions can be written in any suitable high-level language, for example, C, C++, C# or the Java™, and compiled to produce machine-language code for execution by the processor 106.

In an aspect, the user device 102 can comprise a network access device 110 allowing the user device 102 to be coupled to one or more ancillary devices such as via an access point (a network device 126) of a wireless telephone network, local area network, or other coupling to a wide area network, for example, the Internet. In that regard, the processor 106 can be configured to share data with the one or more ancillary devices via the network access device 110. The shared data can comprise, for example, call data, messaging data, usage data, location data, and/or operational data of the user device 102, a status of the user device 102, a status and/or operating condition of one or more the components of the user device 102, text to be used in a message, a product order, payment information, and/or any other data. Similarly, the processor 106 can be configured to receive control instructions from the one or more ancillary devices via the network access device 110. For example, a configuration of the user device 102, an operation of the user device 102, and/or other settings of the user device 102, can be controlled by the one or more ancillary devices via the network access device 110. For example, an ancillary device can comprise the computing device 104 that can provide various services.

In an aspect, the user device 102 can comprise a global positioning system (GPS) unit 112. The GPS unit 112 can detect a current location of the user device 102. In some aspects, a user can request access to one or more services that rely on a current location of the user. For example, a processor in the user device 102 can receive location data from the GPS unit 112, convert it to usable data, and transmit the usable data to the one or more services via the network access device 110. GPS unit 112 can receive position information from a constellation of satellites operated by the U.S. Department of Defense. Alternately, the GPS unit 112 can be a GLONASS receiver operated by the Russian Federation Ministry of Defense, or any other positioning device capable of providing accurate location information (for example, LORAN, inertial navigation, and the like). The GPS unit 112 can contain additional logic, either software, hardware or both to receive the Wide Area Augmentation System (WAAS) signals, operated by the Federal Aviation Administration, to correct dithering errors and provide the most accurate location possible. Overall accuracy of the positioning equipment subsystem containing WAAS is generally in the two meter range.

The user device 102 can comprise a communication element 114 for providing an interface to a user to interact with the user device 102 and/or the computing device 104. The communication element 114 can be any interface for presenting and/or receiving information to/from the user, such as user feedback. An example interface may be communication interface such as a web browser (e.g., Internet Explorer, Mozilla Firefox, Google Chrome, Safari, or the like). Other software, hardware, and/or interfaces can be used to provide communication between the user and one or more of the user device 102 and the computing device 104. The communication element 114 can request or query various files from a local source and/or a remote source. For example, the communication element 114 can transmit to and receive data from a local or remote device such as the computing device 104. As a further example, the communication element 114 can utilize the network access device 110 to transmit to and receive data from a local or remote service provider 116 and/or the computing device 104 associated with travel (airline reservation, car rental, hotel, accommodations, dining, commercial activity, weather service, etc.).

The service provider 116 can comprise any service provider a user might encounter during travel. For example, the service provider 116 can comprise an airline, through which the user books a flight. The service provider 116 can comprise a coffee shop at which the user purchases food and/or drinks. The service provider 116 can comprise a retail shop at an airport at which the user purchases an item. The service provider 116 can comprise a rental car company from which the user rents a vehicle. The service provider 116 can comprise a restaurant at which the user purchases food and/or drinks. The service provider 116 can comprise an entertainment facility (e.g., arcade, driving range, casino, concert venue, and the like) at which the user spends time and money on entertainment related activities. In an aspect, a user of the user device 102 can comprise an account with the service provider 116 for the purpose of tracking interactions between the user/user device 102 and the service provider 116. Travel data can comprise, for example, scheduled flights, scheduled meetings, scheduled travel routes, social events, and/or any other similar occurrence. Travel data can comprise time and location the user device 102, commercial transactions involving a user of the user device 102, frequent operational settings and/or measurements associated with the user device (e.g., airplane mode, Wi-Fi enabled/disabled, accelerometer measurements, etc.). For example, purchases made (along with associated date data, time data, purchase amount data, location data, nearby users data, combinations thereof, and the like) can be tracked via the account. Data generated based on the interactions between the user/user device 102 and the service provider 116 can be transmitted to the user device 102 for storage in the memory device 108 and/or processing by the processor 106, stored at the service provider 116, transmitted to the computing device 104 for storage and/or processing, combinations thereof, and the like. Data can be transmitted by and between any of the user device 102, the service provider 116, and/or the computing device 104 either locally (e.g., Bluetooth) or via the network 105. In an aspect, the user device 102 can be used to effectuate the interactions with the service provider 116. For example, the user device 102 can be comprise one or more software applications (“apps”) through which a user can make a purchase. In some aspects the apps are specific to a service provider 116 and in other aspects a single app can be used to interact with multiple service providers 116. The data thus generated can be referred to as “travel data.” The travel data can be collected to build a historical record of a user's travels over time. The travel data can also be collected and analyzed in real-time. In an aspect, the travel data can further comprise data from other sources such as a weather service and/or a social media service.

In an aspect, travel data can be extracted from one or more communications between the service provider 116 and the user/user device 102. For example, in the event a user books a flight through an airline or travel agency, travel data can be extracted from a confirmation email sent to the user/user device 102. In another aspect, the travel data is transmitted and/or stored upon generation.

In an aspect, the user device 102 can be associated with a user identifier or device identifier 118. As an example, the identifier 118 can be any identifier, token, character, string, or the like, for differentiating one user or user device (e.g., user device 102) from another user or user device. In a further aspect, the identifier 118 can identify a user or user device as belonging to a particular class of users or user devices. As a further example, the identifier 118 can comprise information relating to the user device such as a manufacturer, a model or type of device, a service provider associated with the user device 102, a state of the user device 102, a locator, and/or a label or classifier. Other information can be represented by the identifier 118. The identifier 118 can be associated with the travel data and can accompany transmissions of the travel data to ensure the travel data is associated with the correct user/user device 102. In an aspect, the identifier can be used to encrypt the travel data (e.g., hash).

In an aspect, a travel data analysis module 120 can analyze the travel data. In an aspect, the travel data analysis module 120 can be resident on the user device 102, the service provider 116, the computing device 104, combinations thereof, and the like. The travel data analysis module 120 can identify logical relationships within and among the travel data. The travel data analysis module 120 can generate one or more predictions based on the analysis. The travel data can be used in regression models and/or neural network models for the detection of certain behaviors or patterns. In an aspect, a predictive model may be developed to predict spending at service providers 116, responses to particular offers or other marketing schemes, and the like. The predictive model can be trained using a portion of the travel data. As more travel data is collected, the predictive model will improve. Thus, some or all of the travel data can be used as training data for the predictive model. Based on the travel data, the predictive model is trained, using known techniques such as neural network backward propagation techniques, linear regression, and the like. A predicted response, a predicted interaction, and/or purchasing behavior can then be generated based on input of real-time travel data into the predictive model created with historical travel data.

In an aspect, future interactions (e.g., for time periods for which there is no actual data as of yet) can be predicted based on past travel data. In another aspect, retrospective analysis can be performed by inputting travel data from a recent past time period for which data is available into the predictive model. The travel data can be used to generate the appropriate variables for input into the predictive model. For example, the travel data can be used to build a predictive model that will predict what a user/user device 102 will interact with during the course of travel. For example, if the travel data reflects that a user device 102 is always located at a coffee shop after arrival at an airport, the predictive model, when presented with real-time data indicating that the user device 102 just arrived at an airport, can predict that the user behavior will be to seek out a coffee shop in the near term. In another aspect, if the user device 102 is used in a transaction at a specific service provider 116 and/or a specific type of service provider 116 when the user device 102 is in between arrival at an airport and departure from the airport (e.g., on a “trip”), then the predictive model, when presented with real-time data indicating that the user device 102 is on a trip, can predict that the user behavior will be to seek out the specific service provider 116 and/or a specific type of service provider 116 in the near term.

In an aspect, a recommendation module 122 can generate one or more recommendations to the user/user device 102 based on output from the travel data analysis module 120. The one or more recommendations can be referred to as itinerary information which can comprise, for example, a calendar appointment for an interaction with a service provider 116, a location of, and/or or route to, a service provider 116, an offer or advertisement for a service provider 116, and/or any other information related to an interaction that the user/user device 102 might be likely to engage in with one or more service providers 102. The recommendation module 122 can access one or more sources of data related to service providers 116. In an aspect, the recommendation module 122 can request data to be used in a recommendation directly from the service providers 116. In another aspect, a database of service provider 116 information (e.g., locations, special offers, etc. . . . ) can be maintained on by the recommendation module 122. For example, if the travel data analysis module 120 indicates that the user behavior will be to seek out a coffee shop in the near term, the recommendation module 122 can access the database of service provider 116 information to determine a coffee shop in proximity to the user device 102 and provide the locations of any coffee shops in proximity to the user device 102. In the event that the travel data analysis module 120 indicates that the user behavior will be to seek out a specific coffee shop, the recommendation module 122 can access the database of service provider 116 information to determine whether the specific coffee shop is in proximity to the user device 102 and provide the location(s) of the specific coffee shop in proximity to the user device 102. By way of further example, if the travel data analysis module 120 indicates that the user behavior will be to dine at a specific service provider 116 based on past travel data indicating that the user dines at the specific service provider 116 whenever traveling to the user device 102 current location, then the recommendation module 122 can access the service provider 116 and automatically make one or more temporary reservations for dinner. The temporary reservations can be provided to the user device 102 for acceptance or denial by the user.

In an aspect, the recommendation module 122 and the database of service provider 116 information can be resident on the user device 102, the service provider 116, the computing device 104, combinations thereof, and the like. In an aspect, the recommendation module 122 and the database of service provider 116 information can be stored separately.

In an aspect, the computing device 104 can be a server for communicating with the user device 102. As an example, the computing device 104 can communicate with the user device 102 for providing data and/or services. The data and/or services can comprise storage/processing of travel data, storage/processing of the travel data analysis module 120, storage/processing of the travel data analysis module 122, combinations thereof, and the like. In an aspect, the computing device 104 can allow the user device 102 to interact with remote resources such as data, devices, service providers, and files. As an example, the computing device 104 can be configured as (or disposed at) a central location, which can receive travel data from multiple sources (e.g., the user device 102 and/or the service provider 116).

In an aspect, the computing device 104 can manage the communication between the user device 102 and a database 124 for sending and receiving data therebetween. As an example, the database 124 can store travel data, identifier 118, and/or other information. As a further example, the user device 102 can request and/or retrieve a file from the database 124. In an aspect, the database 124 can store travel data relating to the user device 102. As an example, the computing device 104 can obtain the identifier 108 from the user device 102 and retrieve travel data from the database 124. The computing device 104 can also receive and store travel data received from the service provider 116 in the database 124. Any information can be stored in and retrieved from the database 124. The database 124 can be disposed remotely from the computing device 104 and accessed via direct or indirect connection. The database 124 can be integrated with the computing device 104 or some other device (e.g., user device 102, network device 126) or system.

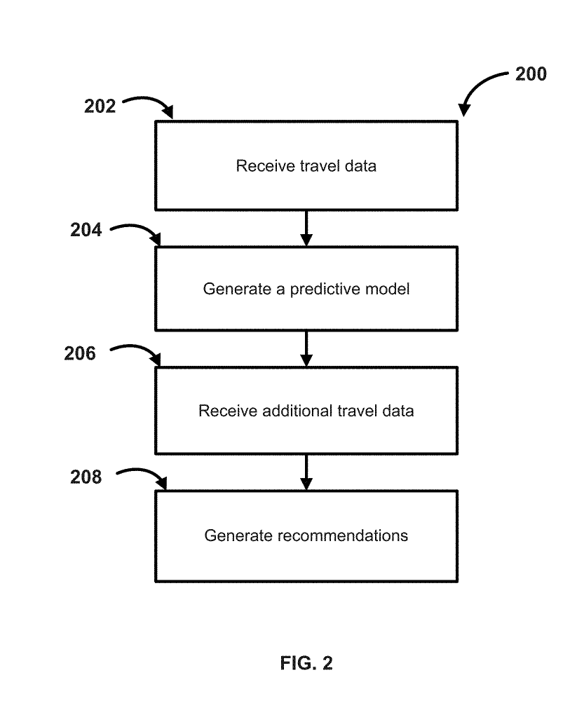

FIG. 2 is a flowchart illustrating an example method 200. In step 202 a user device (e.g., user device 102), can receive travel data. In an aspect, the travel data can be from a plurality of service providers (e.g., airline service provider, hotel and accommodations service provider, location and map service provider, weather service provider, communication service provider, recreational service provider, etc.). In an aspect, the travel data can be derived from and/or extracted from communications associated with a user (e.g., email, social media, SMS message, applications, etc.). In an aspect, the travel data can be received directly from the plurality of service providers (e.g., via a common gateway interface (GGI), via an open database connection (ODBC), via an application programming interface (API), and the like). The travel data can comprise information associated with a user and/or the user's travel such as airline reservations (e.g., flight check-in information, flight cancellation and/or delay information, security information, adjacent flight schedule information, airline terminal maps, etc.), car rental information (e.g., vehicle availability and pricing information, etc.), company and/or user defined travel policies, weather information, and any other similar information. The travel data can be received and stored over time to create historical travel data.

In step 204, a predictive model can be generated based on the historical travel data. For example, a regression models and/or a neural network model can be used. In an aspect, a neural network can be trained on at least a portion of the historical travel data to generate the predictive model.

In step 206, additional travel data can be received. For example, real-time travel data can be received. In step 208, one or more recommendations can be generated based on applying the predictive model to the additional travel data. For example, the recommendations can include recommendations such as a most efficient and likely option for a user to choose when trying to select a restaurant, hotel, transportation method, or alternate route while traveling. As a further example, the recommendations can comprise notifications and/or indications for user action. The notifications can comprise notifications associated with travel events such as a notification of a flight delay. The notifications associated with travel events can be comprised in an application, SMS message, email, and/or the like. The indications for user action can comprise one or more indications such as a query as to whether a user would like to select and/or schedule an alternate flight based on the notification of the flight delay. In an aspect, the recommendations associated with the user can include attractions, occurrences, or events of interest, such as concerts, plays, exhibitions, sporting events, dining locations, commercial outlets, and/or the like.

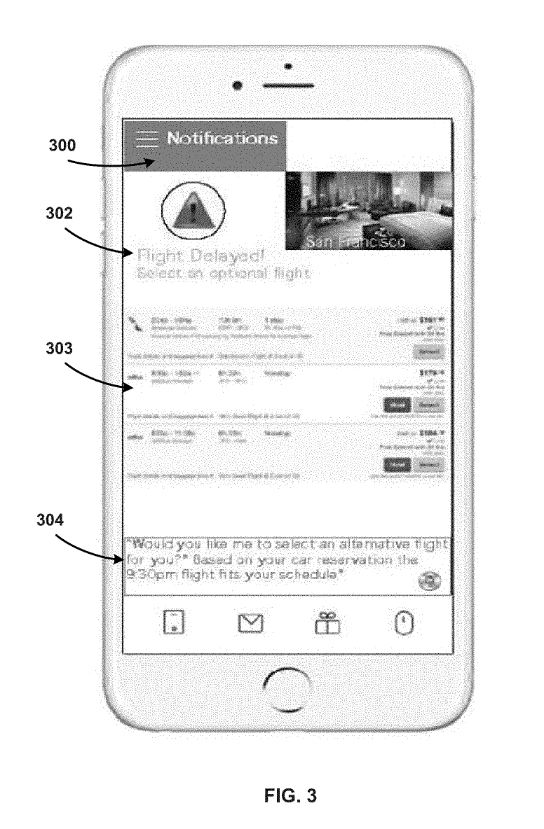

FIG. 3 is a front view of a mobile device illustrating a recommendation to a user comprised in a notification. In an aspect, the mobile device can be a user device 102. In an aspect, the mobile device can provide a notification 300 that informs a user of a flight delay 302. The notification 300 can comprise a list of alternate flights 303 based on travel data associated with the user. The notification 300 can comprise the recommendation to the user 304 that is an option for the user to select an alternate flight based on the user's car reservations (e.g., travel data).

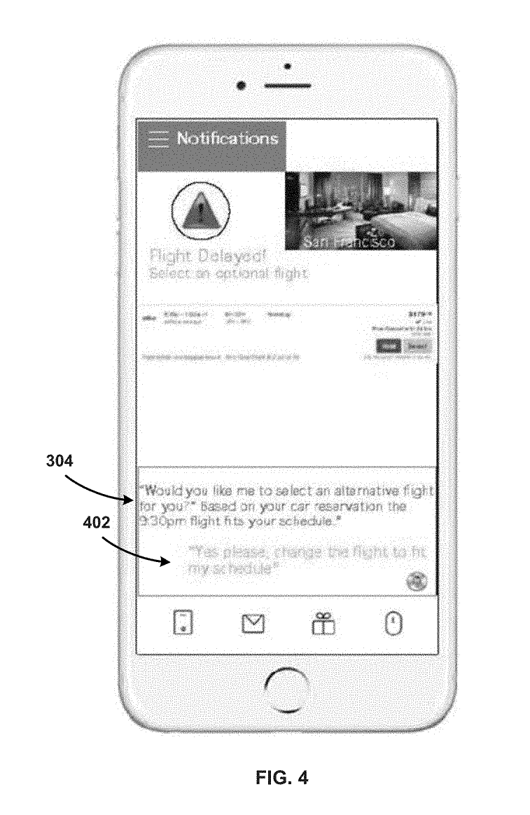

FIG. 4 is a front view of a mobile device illustrating a recommendation to a user comprised in a notification. In an aspect, the mobile device can be a user device 102. In an aspect, based on the recommendation to the user 304, a user can request an alternate flight that coincides with the user's schedule (e.g., travel data) 402.

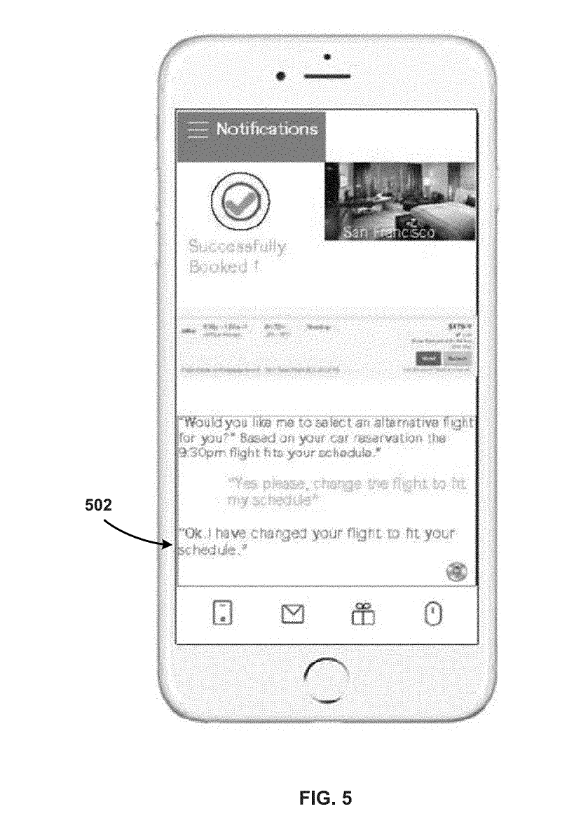

FIG. 5 is a front view of a mobile device illustrating a recommendation to a user comprised in a notification. In an aspect, the mobile device can be a user device 102. In an aspect, based on the user requesting an alternate flight that coincides with the user's schedule (e.g., travel data), the user can be provided confirmation of alternate flight plans 502 based on the user's schedule (e.g., travel data).

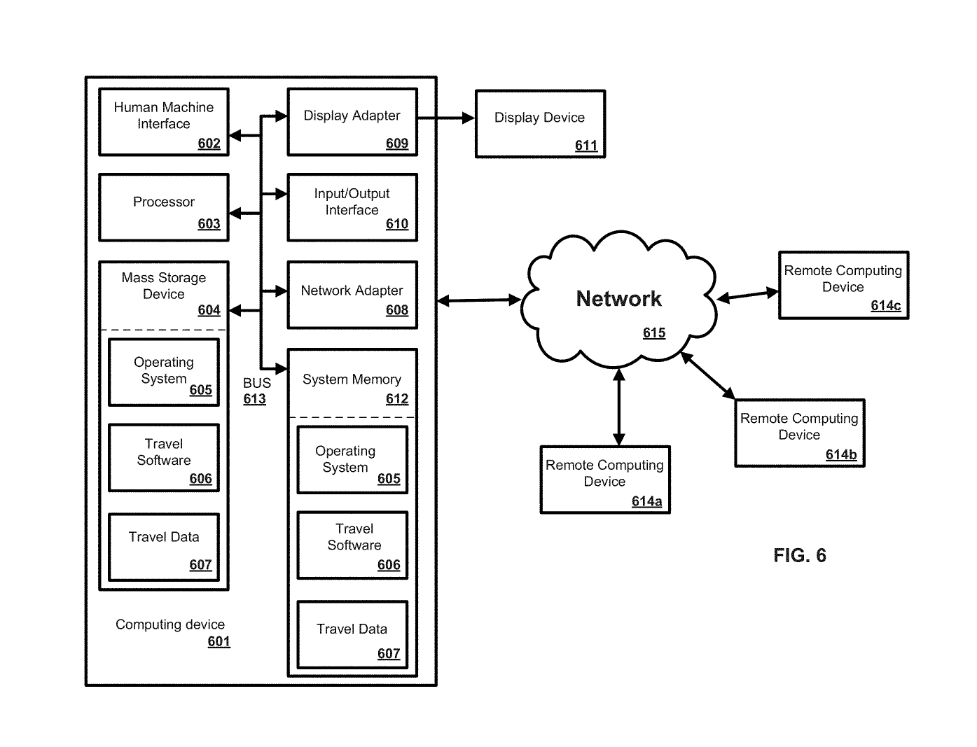

In an exemplary aspect, the methods and systems can be implemented on a computing system, such as computing device 601 as illustrated in FIG. 6 and described below. By way of example, one or more of the user device 102 and the computing device 104 of FIG. 1 can be a computer as illustrated in FIG. 6. Similarly, the methods and systems disclosed can utilize one or more computers to perform one or more functions in one or more locations. FIG. 6 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computing device 601. The components of the computing device 601 can comprise, but are not limited to, one or more processors or processing units 603, a system memory 612, and a system bus 613 that couples various system components including the processor 603 to the system memory 612. In the case of multiple processing units 603, the system can utilize parallel computing.

The system bus 613 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description can also be implemented over a wired or wireless network connection and each of the subsystems, including the processor 603, a mass storage device 604, an operating system 605, travel software 606, travel data 607, a network adapter 608, system memory 612, an Input/Output Interface 610, a display adapter 609, a display device 611, and a human machine interface 602, can be contained within one or more remote computing devices 614a,b,c at physically separate locations, connected through buses of this form, in effect implementing a fully distributed system.

The computing device 601 typically comprises a variety of computer readable media. Exemplary readable media can be any available media that is accessible by the computing device 601 and comprises, for example and not meant to be limiting, both volatile and non-volatile media, removable and non-removable media. The system memory 612 comprises computer readable media in the form of volatile memory, such as random access memory (RAM), and/or non-volatile memory, such as read only memory (ROM). The system memory 612 typically contains data, such as travel data 607, and/or program modules, such as operating system 605 and travel software 606, that are immediately accessible to and/or are presently operated on by the processing unit 603.

In another aspect, the computing device 601 can also comprise other removable/non-removable, volatile/non-volatile computer storage media. By way of example, FIG. 6 illustrates a mass storage device 604 which can provide non-volatile storage of computer code, computer readable instructions, data structures, program modules, and other data for the computing device 601. For example and not meant to be limiting, a mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), solid state drives, and the like.

Optionally, any number of program modules can be stored on the mass storage device 604, including by way of example, an operating system 605 and travel software 606. Each of the operating system 605 and travel software 606 (or some combination thereof) can comprise elements of the programming and the travel software 606. Travel data 607 can also be stored on the mass storage device 604. Travel data 607 can be stored in any of one or more databases known in the art. Examples of such databases comprise, DB2®, Microsoft® Access, Microsoft® SQL Server, Oracle®, MySQL, PostgreSQL, and the like. The databases can be centralized or distributed across multiple systems.

In another aspect, the user can enter commands and information into the computing device 601 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 603 via a human machine interface 602 that is coupled to the system bus 613, but can be connected by other interface and bus structures, such as a parallel port, game port, an IEEE 1394 Port (also known as a Firewire port), a serial port, or a universal serial bus (USB).

In yet another aspect, a display device 611 can also be connected to the system bus 613 via an interface, such as a display adapter 609. It is contemplated that the computing device 601 can have more than one display adapter 609 and the computer 601 can have more than one display device 611. For example, a display device can be a monitor, an LCD (Liquid Crystal Display), or a projector. In addition to the display device 611, other output peripheral devices can comprise components, such as speakers (not shown) and a printer (not shown) which can be connected to the computing device 601 via Input/Output Interface 610. Any step and/or result of the methods can be output in any form to an output device. Such output can be any form of visual representation, including, but not limited to, textual, graphical, animation, audio, tactile, and the like. The display 611 and computing device 601 can be part of one device, or separate devices.

The computing device 601 can operate in a networked environment using logical connections to one or more remote computing devices 614a,b,c. By way of example, a remote computing device can be a personal computer, portable computer, a smart phone, a server, a router, a network computer, a peer device or other common network node, and so on. Logical connections between the computing device 601 and a remote computing device 614a,b,c can be made via a network 615, such as a local area network (LAN) and a general wide area network (WAN). Such network connections can be through a network adapter 608. A network adapter 608 can be implemented in both wired and wireless environments. Such networking environments are conventional and commonplace in dwellings, offices, enterprise-wide computer networks, intranets, and the Internet.

For purposes of illustration, application programs and other executable program components, such as the operating system 605, are illustrated herein as discrete blocks, although it is recognized that such programs and components reside at various times in different storage components of the computing device 601, and are executed by the data processor(s) of the computer. An implementation of travel software 606 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information, such as computer readable instructions, data structures, program modules, or other data Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation: the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
receiving travel data associated with a user;
generating a predictive model;
receiving additional travel data associated with the user; and
generating, based on applying the predictive model to the additional travel data, one or more recommendations.

2. The method of claim 1, further comprising providing the one or more recommendations to the user.

3. The method of claim 1, wherein receiving the travel data associated with a user comprises receiving the travel data from one or more service providers.

4. The method of claim 3, wherein receiving the travel data from one or more service providers comprises receiving the travel data via an application programming interface or an electronic mail.

5. The method of claim 1, wherein generating a predictive model comprises training a neural network on the travel data.

6. The method of claim 1, wherein receiving the additional travel data associated with the user comprises receiving the additional travel data from one or more service providers.

7. The method of claim 6, wherein receiving the additional travel data from one or more service providers comprises receiving the additional travel information via an application programming interface or an electronic mail.

8. The method of claim 1, wherein receiving the additional travel data associated with the user comprises receiving the additional travel data in real-time.

9. The method of claim 5, further comprising receiving travel data associated with a user over a period of time to generate historical travel data.

10. The method of claim 9, comprising training the neural network on the historical travel data.

11. The method of claim 1, wherein generating, based on applying the predictive model to the additional travel data, one or more recommendations comprises:
determining one or more predicted interactions;
determining one or more service providers associated with the one or more predicted interactions; and
providing an indication of the one or more service providers to the user as the one or more recommendations.

12. An apparatus comprising:
one or more processors; and
a memory comprising processor executable instructions that, when executed by the one or more processors, cause the apparatus to:
receive travel data associated with a user;
generate a predictive model;
receive additional travel data associated with the user; and
generate, based on applying the predictive model to the additional travel data, one or more recommendations.

13. The apparatus of claim 12, wherein the processor executable instructions that, when executed by the one or more processors, further cause the apparatus to provide the one or more recommendations to the user.

14. The apparatus of claim 12, wherein the processor executable instructions that, when executed by the one or more processors, cause the apparatus to receive the travel data associated with a user further comprise processor executable instructions that, when executed by the one or more processors, cause the apparatus to receive the travel data from one or more service providers.

15. The apparatus of claim 14, wherein the processor executable instructions that, when executed by the one or more processors, cause the apparatus to receive the travel data from one or more service providers further comprise processor executable instructions that, when executed by the one or more processors, cause the apparatus to receive the travel data via an application programming interface or an electronic mail.

16. The apparatus of claim 12, wherein the processor executable instructions that, when executed by the one or more processors, cause the apparatus to generate a predictive model further comprise processor executable instructions that, when executed by the one or more processors, cause the apparatus to train a neural network on the travel data.

17. The apparatus of claim 12, wherein the processor executable instructions that, when executed by the one or more processors, cause the apparatus to receive the additional travel data associated with the user further comprise processor executable instructions that, when executed by the one or more processors, cause the apparatus to receive the additional travel data from one or more service providers.

18. The apparatus of claim 17, wherein the processor executable instructions that, when executed by the one or more processors, cause the apparatus to receive the additional travel data from one or more service providers further comprise processor executable instructions that, when executed by the one or more processors, cause the apparatus to receive the additional travel information via an application programming interface or an electronic mail.

19. The apparatus of claim 12, wherein the processor executable instructions that, when executed by the one or more processors, cause the apparatus to receive the additional travel data associated with the user further comprise processor executable instructions that, when executed by the one or more processors, cause the apparatus to receive the additional travel data in real-time.

20. One or more non-transitory computer readable media storing processor executable instructions that, when executed by at least one processor cause the at least one processor to:
receive travel data associated with a user;
generate a predictive model;
receive additional travel data associated with the user; and
generate, based on applying the predictive model to the additional travel data, one or more recommendations.
